(19) United States
(12) Patent Application Publication
(10) Pub. No.: US 2014/0099531 A1
(43) Pub. Date: Apr. 10, 2014

(54) SULFIDE-BASED SOLID CELL MODULE

(71) Applicants: Kyoko Kumagai, Mishima-shi (JP); Yushi Suzuki, Susono-shi (JP)

(72) Inventors: Kyoko Kumagai, Mishima-shi (JP); Yushi Suzuki, Susono-shi (JP)

(21) Appl. No.: 13/388,372

(22) PCT Filed: May 24, 2011
(86) PCT No.: PCT/JP11/61883

§ 371 Date: Mar. 9, 2012

(51) Int. Cl. H01M 10/04

(52) U.S. Cl. CPC H01M 10/0463
USPC 429/163

(57) ABSTRACT

An object of the present invention is to provide a sulfide-based solid cell module which prevents a deterioration in negative electrode caused by hydrogen sulfide.

Disclosed is a sulfide-based solid cell module comprising a sulfide-based solid cell which comprises a positive electrode, a negative electrode and a sulfide-based solid electrolyte between the positive and negative electrodes, and a cell case for housing the sulfide-based solid cell, wherein the negative electrode is on the upper side of the vertical direction of the solid cell than the positive electrode, and wherein a gas having a lower density than hydrogen sulfide is contained in the cell case.

### CROSS-REFERENCE TO RELATED APPLICATIONS

This application is a national phase application of International Application No. PCT/JP2011/061883, filed May 24, 2011, the contents of which are incorporated herein by reference.

### TECHNICAL FIELD

The present invention relates to a sulfide-based solid cell module which prevents a deterioration in negative electrode caused by hydrogen sulfide.

### BACKGROUND ART

A secondary battery is a battery which is able to provide electricity by converting a loss in chemical energy into electrical energy; moreover, it is a battery which is able to store (during charge) chemical energy by converting electrical energy into chemical energy by passing an electrical current in a direction that is opposite to the discharge direction. Among secondary batteries, lithium ion batteries have higher energy density, so that they are widely used as a power source for notebook personal computers, cellular phones, etc.

In a lithium secondary battery using graphite (C) as the negative electrode active material, the reaction described by the following formula (I) proceeds at the negative electrode upon discharge:

LiₓC→C+xLi⁺+xe⁻ (I)

wherein 0<x<1.

An electron produced by the formula (I) passes through an external circuit, works by an external load, and then reaches the positive electrode. At the same time, a lithium ion (Li⁺) produced by the formula (I) is transferred through the electrolyte sandwiched between the negative and positive electrodes from the negative electrode side to the positive electrode side by electro-osmosis.

When lithium cobaltate (Li₁₋ₓCoO₂) is used as a positive electrode active material, a reaction described by the following formula (II) proceeds at the positive electrode upon discharge:

Li₁₋ₓCoO₂+xLi⁺xe⁻→LiCoO₂ (II)

wherein 0<x<1.

Upon charging the battery, reactions which are reverse to the reactions described by the above formulae (I) and (II) proceed at the negative and positive electrodes. The graphite material in which lithium was intercalated (LiₓC) becomes reusable at the negative electrode, while lithium cobaltate (Li₁₋ₓCoO₂) is regenerated at the positive electrode. Because of this, discharge becomes possible again.

Among lithium secondary batteries, a lithium secondary battery all-solidified by using a solid electrolyte as the electrolyte, uses no combustible organic solvent in the battery; therefore, it is considered to be safe, able to contribute to device simplification and excellent in production cost and productivity. A sulfide-based solid electrolyte is known as a solid electrolyte material used for such a solid electrolyte.

However, a sulfide-based solid electrolyte material is likely to react with moisture. Because of this, a battery comprising a sulfide-based solid electrolyte material has a problem that a deterioration is likely to be caused to the battery by the generation of hydrogen sulfide, thereby shortening the lifetime of the battery.

Techniques which aim at trapping hydrogen sulfide gas and detoxifying it, have been developed. A sulfide-based secondary battery technique is disclosed in Patent Literature 1, in which a sulfur compound that generates hydrogen sulfide gas when decomposed is contained in cells and the outer surface of the cells is covered with a substance that traps hydrogen sulfide gas and detoxifying it.

### CITATION LIST

Patent Literature 1: Japanese Patent Application Laid-Open (JP-A) No. 2008-103245

### SUMMARY OF INVENTION

### Technical Problem

In Paragraph [0021] of Patent Literature 1, an alkaline substance is mentioned as an example of the substance which traps hydrogen sulfide gas and detoxifying it. However, since no alkaline substances directly relate to charge and discharge, it is not preferable to use an alkaline substance from the viewpoint of costs for preparing the alkaline substance, an increase in the weight of the whole cells due to containing the alkaline substance, and a decrease in the volumetric efficiency of the cells.

The present invention was achieved in light of the above circumstance. An object of the present invention is to provide a sulfide-based solid cell module which prevents a deterioration in negative electrode caused by hydrogen sulfide.

### Solution to Problem

The sulfide-based solid cell module of the present invention comprises a sulfide-based solid cell which comprises a positive electrode, a negative electrode and a sulfide-based solid electrolyte between the positive and negative electrodes, and a cell case for housing the sulfide-based solid cell, wherein the negative electrode is on the upper side of the vertical direction of the solid cell than the positive electrode, and wherein a gas having a lower density than hydrogen sulfide is contained in the cell case.

In the present invention, the negative electrode can comprise a negative electrode active material layer and a negative electrode current collector, and the negative electrode current collector can comprise at least one kind of electroconductive material selected from the group consisting of copper, nickel, and stainless steel.

In the present invention, the gas having a lower density than hydrogen sulfide can be at least one kind of gas selected from the group consisting of nitrogen (N₂), oxygen (O₂), carbon monoxide (CO), helium (He) and hydrogen (H₂).

### Advantageous Effects of Invention

According to the present invention, it is possible to prevent a deterioration in negative electrode caused by hydrogen sulfide because, even in the case where hydrogen sulfide is generated, the hydrogen sulfide stays on the lower side of the vertical direction of the sulfide-based solid cell; therefore, it is possible to prevent a deterioration in the negative electrode caused by hydrogen sulfide.

### BRIEF DESCRIPTION OF DRAWINGS

FIGS. 1(a) and 1(b) are each a view showing a typical example of the stacking structure of the sulfide-based solid cell module of the present invention and is also a schematic view showing a section of the module cut along the stacking direction.

FIG. 2 is a view showing a variation of the stacking structure of the sulfide-based solid cell module of the present invention and is also a schematic view showing a section of the module cut along the stacking direction.

FIGS. 3(a), 3(b), and 3(c) are each a photograph of a copper foil before exposure to hydrogen sulfide, a photograph of the same after the exposure, and a graph showing results of XPS depth profile analysis of the copper after the exposure.

FIGS. 4(a), 4(b), and 4(c) are each a photograph of a SUS foil before exposure to hydrogen sulfide, a photograph of the same after the exposure, and a graph showing results of XPS depth profile analysis of the SUS after the exposure.

FIGS. 5(a), 5(b), and 5(c) are each a photograph of an aluminum foil before exposure to hydrogen sulfide, a photograph of the same after the exposure, and a graph showing results of XPS depth profile analysis of the aluminum after the exposure.

FIG. 6 is a bar graph showing the contact resistance of the copper foil and that of the aluminum foil before and after the exposure to hydrogen sulfide.

### DESCRIPTION OF EMBODIMENTS

The sulfide-based solid cell module of the present invention comprises a sulfide-based solid cell which comprises a positive electrode, a negative electrode and a sulfide-based solid electrolyte between the positive and negative electrodes, and a cell case for housing the sulfide-based solid cell, wherein the negative electrode is on the upper side of the vertical direction of the solid cell than the positive electrode, and wherein a gas having a lower density than hydrogen sulfide is contained in the cell case.

In the present invention, “density of gas” means the density of a gas at a standard condition (0° C., 101.325 kPa).

Also in the present invention, “the negative electrode is on the upper side of the vertical direction of the solid cell than the positive electrode” means the following positional relationship between the negative and positive electrode. That is, it is such a relationship that a line may touch a positive electrode when the line is dropped from an optional position of a negative electrode, while a line never touches a negative electrode when the line is dropped from an optional position of a positive electrode.

In the case of a sulfide-based solid cell comprising a sulfide-based solid material, the sulfide-based solid material sometimes reacts with a slight amount of moisture to generate hydrogen sulfide (H₂S), which is contained in the material of the sulfide-based solid cell or which enters from the air through an exterior resin member that covers the sulfide-based solid cell.

The reason for the entering of a small amount of moisture into the sulfide-based solid cell is thought to be due to water which entered during production or permeation of water from a sealing part when used. To prevent the entering of water during production, it is possible to take a step of producing a cell inside a dry room at a controlled dew-point temperature or inside a glove box. To prevent the permeation of water from a sealing part when used, it is possible to improve the material or structure of the sealing part.

In conventional arts, however, it is still difficult to completely prevent the entering of water into a cell even after taking the above steps.

In general, compared with the atmosphere which fills the sulfide-based solid cell (such as dry air), hydrogen sulfide has higher density (1.54 kg/m³) in the standard condition. Therefore, a generated hydrogen sulfide gathers on the lower side of the vertical direction of the sulfide-based solid cell. As a result, in the case where the negative electrode is on the lower side of the vertical direction of the solid cell than the positive electrode, the metal used for the negative electrode current collector, such as copper, is likely to be corroded (sulfurated). Also, there may be a deterioration in cell performance due to the corrosion.

The inventors of the present invention found that by providing the negative electrode on the upper side of the vertical direction of the solid cell than the positive electrode and filling the cell case with a gas having a lower density than hydrogen sulfide, it is possible to prevent a deterioration in negative electrode caused by hydrogen sulfide because, even in the case where hydrogen sulfide is generated, the hydrogen sulfide stays on the lower side of the vertical direction of the sulfide-based solid cell. The inventors achieved the present invention based on this knowledge.

Generally in the field of sulfide-based solid cell technology, the sulfide-based solid cell has not been discussed very much from the point of view of which of the positive and negative electrodes should be provided on the upper side of the vertical direction of the solid cell.

However, the inventors of the present invention focused attention on an issue which has not been particularly discussed, that is, the positional relationship of the upper and lower sides of the positive and negative electrodes, and they studied providing the negative electrode on the upper side of the vertical direction of the solid cell than the positive electrode. As a result, they found an advantage that corrosion of cell components due to hydrogen sulfide can be avoided by using a gas having a lower density than hydrogen sulfide as the atmosphere inside the cell case, in addition to providing the negative electrode on the upper side of the vertical direction than the positive electrode.

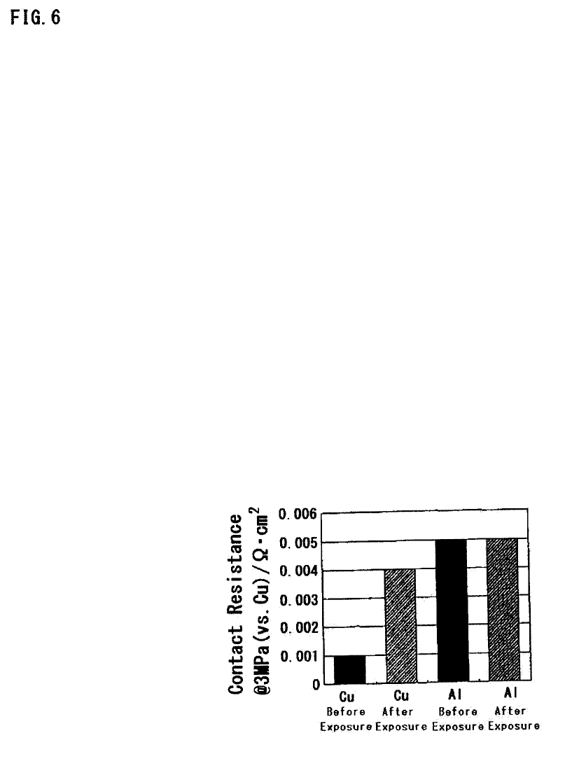

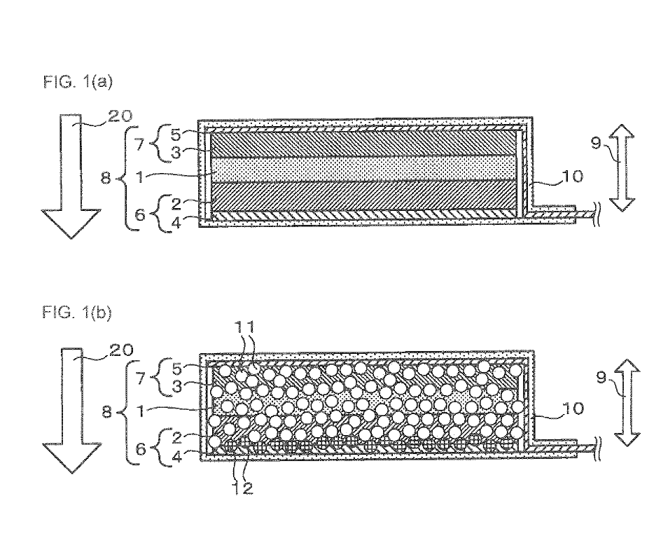

FIG. 1(a) is a view showing a typical example of the stacking structure of the sulfide-based solid cell module of the present invention and is also a schematic view showing a section of the module cut along the stacking direction. The double wavy line shown in the figure indicates the omission of a part of the figure.

As shown in FIG. 1(a), sulfide-based solid cell 8 comprises positive electrode 6 comprising positive electrode active material layer 2 and positive electrode current collector 4, negative electrode 7 comprising negative electrode active material layer 3 and negative electrode current collector 5, and sulfide-based solid electrolyte 1 sandwiched between positive electrode 6 and negative electrode 7.

As shown in FIG. 1(a), stacking direction 9, which is the stacking direction of the components in sulfide-based solid cell 8, is substantially the same as vertical direction 20. In the present invention, “stacking direction” is a direction in which layers are stacked and is also a direction which is substantially vertical to the planar direction of the layers. Negative electrode 7 is provided to be on the upper side of the vertical direction of the solid cell than positive electrode 6.

The whole of sulfide-based solid cell 8 is housed in cell case 10, except a terminal of positive electrode current collector 4 and that of negative electrode current collector 5. Positive electrode current collector 4 is extended in the direction toward or away from the viewer of FIG. 1(a), while a part of positive electrode current collector 4 is exposed on the outside of cell case 10, both of which are not shown in FIG. 1(a). In addition, cell case 10 is filled with a gas having a lower density than hydrogen sulfide, which is not shown in FIG. 1(a).

FIG. 1(b) is a schematic view showing the distribution of the gas filling the cell case when the sulfide-based solid cell module of the typical example is in use. White circle 11 means the gas having a lower density than hydrogen sulfide, while circle 12 means hydrogen sulfide. The double wavy line shown in the figure indicates the omission of a part of the figure.

As shown in FIG. 1(b), the gas filling cell case 10 occupies the upper side of the vertical direction of sulfide-based solid cell 8 than hydrogen sulfide 12. Also in this typical example, negative electrode 7 is on the upper side of the vertical direction of the solid cell than positive electrode 6. Therefore, in the case where hydrogen sulfide is generated, the hydrogen sulfide stays on the lower side of the vertical direction of the sulfide-based solid cell, so that it is possible to prevent a deterioration in the negative electrode caused by hydrogen sulfide.

FIG. 2 is a view showing a variation of the stacking structure of the sulfide-based solid cell module of the present invention and is also a schematic view showing a section of the module cut along the stacking direction. The double wavy line shown in the figure indicates the omission of a part of the figure.

This variation shows a stack of cell cases 10, each of which comprises sulfide-based solid cell 8 and is shown in FIG. 1(a). In this variation, as shown in FIG. 2, stacking direction 9, which is the stacking direction of the components in sulfide-based solid cell 8, is substantially the same as direction 19 in which cell cases 10 are stacked, and direction 19 is substantially the same as vertical direction 20.

As shown in FIG. 2, also in this variation, negative electrode 7 is on the upper side of the vertical direction of the solid cell than positive electrode 6. In cell case 10, the gas having a lower density than hydrogen sulfide occupies the upper side of the vertical direction of sulfide-based solid cell 8 than hydrogen sulfide, which is not shown in FIG. 2. Therefore, also in this variation, it is possible to prevent a deterioration in the negative electrode caused by hydrogen sulfide, as with the above typical example.

The embodiment of the present invention is not limited to the above typical example and variation. When installing the sulfide-based solid cell module of the present invention, it is assembled so that the negative electrode is on the upper side of the vertical direction of the solid cell than the positive electrode, and the assembled cell module can be used while fixing the position of the negative and positive electrodes. Also in the present invention, a part or all of the sulfide-based solid cell module can be movable and the inclination of a part or all of the cell module can be adjusted so that the negative electrode is on the upper side of the vertical direction of the solid cell than the positive electrode whenever the cell module is used.

It is not necessary that the stacking direction of the components of the sulfide-based solid cell is substantially the same as the vertical direction as shown in FIGS. 1(a), 1(b), and 2. That is, the stacking direction of the components of the sulfide-based solid cell can be inclined to the vertical direction as long as the negative electrode is on the upper side of the vertical direction of the solid cell than the positive electrode.

Hereinafter, a positive electrode, a negative electrode, a sulfide-based solid electrolyte, a cell case and other components such as a separator will be described in order, which are used for the sulfide-based solid cell module of the present invention.

### (Positive and Negative Electrodes)

The positive electrode used in the present invention preferably comprises a positive electrode current collector and a positive electrode tab connected to the current collector. More preferably, it comprises a positive electrode active material layer containing a positive electrode active material. The negative electrode used in the present invention preferably comprises a negative electrode current collector and a negative electrode tab connected to the current collector. More preferably, it comprises a negative electrode active material layer containing a negative electrode active material.

As the positive electrode active material used in the present invention, in particular, there may be mentioned LiCoO₂, LiNi_{1/3}Mn_{1/3}Co_{1/3}O₂, LiNiPO₄, LiMnPO₄, LiNiO₂, LiMn₂O₄, LiCoMnO₄, Li₂NiMn₃O₈, Li₃Fe₂(PO₄)₃, Li₃V₂(PO₄)₃, etc. The surface of particles comprising the positive electrode active material can be covered with LiNbO₃ or the like.

Of these materials, LiCoO₂ is preferably used as the positive electrode active material in the present invention.

The thickness of the positive electrode active material layer used in the present invention varies depending on the intended application of the sulfide-based solid cell module. However, it is preferably in the range of 5 μm to 250 μm, particularly preferably in the range of 20 μm to 200 μm, most preferably in the range of 30μm to 150 μm.

The average particle diameter of the positive electrode active material is, for example, in the range of 1 μm to 50 μm, preferably in the range of 1 μm to 20 μm, particularly preferably in the range of 3 μm to 5 μm. This is because it could be difficult to handle the positive electrode active material when the average particle diameter of the material is too small, and it could be difficult to make the positive electrode active material layer a flat layer when the average particle diameter of the positive electrode active material is too large. The average particle diameter of the positive electrode active material can be obtained by, for example, measuring the diameter of active material carrier particles observed with a scanning electron microscope (SEM) and averaging the thus-obtained diameters.

As needed, the positive electrode active material layer can contain a conducting material, a binder, etc.

The conducting material contained in the positive electrode active material layer used in the present invention is not particularly limited as long as it can increase the conductivity of the positive electrode active material layer. As the conducting material, for example, there may be mentioned carbon black such as acetylene black, ketjen black or VGCF. The content of the conducting material in the positive electrode active material layer varies depending on the type of conducting material, and it is normally in the range of 1% by mass to 10% by mass.

As the binder contained in the positive electrode active material layer used in the present invention, for example, there may be mentioned synthetic rubbers such as styrene-butadiene rubber, ethylene-propylene rubber and styrene-ethylene-butadiene rubber, and fluorine polymers such as polyvinylidene fluoride (PVDF) and polytetrafluoroethylene (PTFE). The content of the binder in the positive electrode active material layer can be an amount which can fix the positive electrode active material, etc., and it is preferably as small as possible. The content of the binder is normally in the range of 1% by mass to 10% by mass. An increase in the flexibility of the whole solid cell can be expected by containing the binder.

After the positive electrode active material layer is formed, the layer can be pressed to increase electrode density.

The positive electrode current collector used in the present invention is not particularly limited as long as it functions to collect current from the positive electrode active material layer and it contains a substance which is non-reactive with hydrogen sulfide.

As described in Examples below, among copper, SUS and aluminum foils which are generally used for current collectors, aluminum foil is hardly affected by hydrogen sulfide. Therefore, as the material for the positive electrode current collector, for example, there may be mentioned aluminum, aluminum alloys and stainless steel such as SUS. Of these, aluminum and SUS are preferred. As the form of the positive electrode current collector, there may be mentioned a foil form, a plate form and a mesh form, for example. Of these, a foil form is preferred.

The positive electrode tab is a member for connecting the positive electrode current collector with an external load outside the cell or a lead. The positive electrode tab is not particularly limited as long as it is made of the same material as that of the above-described positive electrode current collector. As the material for the positive electrode tab, for example, there may be mentioned aluminum, aluminum alloys and stainless steel such as SUS. Of these, aluminum and SUS are preferred.

From the viewpoint of increasing sealing properties, a dedicated sealing material can be used for a sealing tab of the positive electrode tab and a sealing portion of the below-described cell case. As the dedicated sealing agent, there may be mentioned general-purpose polymers such as polypropylene. It is also possible to use a commercially-available tab lead made of a combination of a positive electrode tab and sealing (manufactured by Sumitomo Electric Industries, Ltd.)

The negative electrode active material used for the negative electrode active material layer is not particularly limited as long as it can store/release a metal ion. In the case of using a lithium ion as the metal ion, for example, there may be mentioned a metallic lithium, a lithium alloy, a metal oxide such as lithium titanate, a metal sulfide, a metal nitride and a carbonaceous material such as graphite, soft carbon or hard carbon. The negative electrode active material can be in a powder form or thin film form.

As needed, the negative electrode active material layer can comprise a conducting material, a binder, etc.

As the conducting material and binder, those that are described above can be used. It is preferable to appropriately select the used amount of the binder and conducting material depending on the intended application of the sulfide-based solid cell module, etc. The thickness of the negative electrode active material layer is not particularly limited. For example, it is in the range of 5 μm to 150 μm, preferably in the range of 10 μm to 80 μm.

The negative electrode current collector used in the present invention is not particularly limited as long as it functions to collect current from the negative electrode active material layer. In the present invention, the sulfide-based solid cell has a structure that the negative electrode current collector hardly touches hydrogen sulfide, so that it is necessary to consider the reactivity of the negative electrode current collector with hydrogen sulfide. Therefore, the negative electrode current collector can contain a substance which is reactive with hydrogen sulfide.

As described in Examples below, among copper, SUS and aluminum foils which are generally used for current collectors, most serious corrosion is caused to copper foil by hydrogen sulfide. Therefore, as the material for the negative electrode current collector, for example, there may be mentioned nickel, copper and stainless steel such as SUS. Of these, copper and SUS are preferred. As the form of the negative electrode current collector, there may be mentioned a foil form, a plate form and a mesh form, for example. Of these, a foil form is preferred.

The negative electrode tab is a member for connecting the negative electrode current collector with an external load outside the cell or a lead. The negative electrode tab is not particularly limited as long as it is made of the same material as that of the above-described negative electrode current collector. As the material for the negative electrode tab, for example, there may be mentioned nickel, copper and stainless steel such as SUS. Of these, copper and SUS are preferred.

The negative electrode tab is the same as the positive electrode tab in that it is possible to use a dedicated sealing material and a tab lead which is a combination of a tab and sealing therefor.

As the production method of the negative electrode used in the present invention, those that are the same as the positive electrode production methods described above, can be used.

The positive electrode and/or negative electrode used in the present invention can comprise a solid electrolyte. As the solid electrolyte, in particular, there may be mentioned an oxide-based solid electrolyte, a polymer electrolyte, a gel electrolyte, etc., besides the sulfide-based solid electrolytes which will be described in detail below.

As the oxide-based solid electrolyte, in particular, there maybe mentioned lithium phosphorus oxynitride (LiPON), Li_{1.3}Al_{0.3}Ti_{0.7}(PO₄)₃, La_{0.51}Li0.34TiO0.74, Li₃PO₄, Li₂SiO₂, Li₂SiO₄, etc.

The polymer electrolyte contains a lithium salt and a polymer. The lithium salt is not particularly limited as long as it is one which is used for general lithium secondary batteries, and there may be mentioned LiPF₆, LiBF₄, LiN(CF₃SO₂)₂, LiCF₃SO₃, LiC₄F₉SO₃, LiC(CF₃SO₂)₃ and LiClO₄, for example. The polymer is not particularly limited as long as it is one which forms a complex in conjunction with a lithium salt. For example, there may be mentioned polyethylene oxide.

The gel electrolyte contains a lithium salt, a polymer and a non-aqueous solvent.

As the lithium salt, the above-mentioned lithium salts can be used.

The non-aqueous solvent is not particularly limited as long as it can dissolve the lithium salt. For example, there may be mentioned propylene carbonate, ethylene carbonate, diethyl carbonate, dimethyl carbonate, ethyl methyl carbonate, 1,2-dimethoxyethane, 1,2-diethoxyethane, acetonitrile, propionitrile, tetrahydrofuran, 2-methyltetrahydrofuran, dioxane, 1,3-dioxolan, nitromethane, N,N-dimethylformamide, dimethylsulfoxide, sulfolane and γ-butyrolactone. These non-aqueous solvents can be used alone or in combination of two or more kinds. Or, an ambient temperature molten salt can be used as a non-aqueous electrolyte.

The polymer is not particularly limited as long as it can gel. For example, there may be mentioned polyethylene oxide, polypropylene oxide, polyacrylonitrile, polyvinylidene fluoride (PVDF), polyurethane, polyacrylate and cellulose.

### (Sulfide-Based Solid Electrolyte)

The sulfide-based solid electrolyte used in the present invention preferably functions to perform ion exchange between the above-described positive electrode active material and the negative electrode active material. As the sulfide-based solid electrolyte, it is also possible to use solid electrolyte crystal.

As the sulfide-based solid electrolyte used in the present invention, in particular, there may be mentioned Li₂S—P₂S₅, Li₂S—P₂S₃, Li₂S—P₂S₃—P₂S₅, Li₂S—SiS₂, Li₂S—Si₂S, Li₂S—B₂S₃, Li₂S—GeS₂, LiI—Li₂S—P₂S₅, LiI—Li₂S—SiS₂—P₂S₅, Li₂S—SiS₂—Li₄SiO₄, Li₂S—SiS₂—Li₃PO₄, Li₃PS₄—Li₄GeS₄, Li_{3.4}P_{0.6}Si_{0.4}S₄, Li_{3.25}P_{0.25}Ge0.76S₄, Li₄₋ₓGe₁₋ₓPₓS₄, etc.

As a method for forming the sulfide-based solid electrolyte into a layer, there may be mentioned a method for pressing the sulfide-based solid electrolyte. The sulfide-based solid electrolyte can be formed into a layer by such a method that the sulfide-based solid electrolyte and a solvent are mixed to form a slurry, and the slurry is applied to a desired part of the positive electrode, the negative electrode, etc.

The sulfide-based solid electrolyte can contain the above-described binder.

### (Cell Case)

The form of the cell case which is usable in the present invention is not particularly limited as long as it can house the positive electrode, the negative electrode, the sulfide-based solid electrolyte, etc. In particular, there may be mentioned a cylinder form, a square form, a coin form, a laminate form, etc. In the case of laminate form, a three-layer film (polyethylene telephthalate/aluminum/polyethylene) can be used as a laminate film.

In the cell case, a gas having a lower density than hydrogen sulfide (density: 1.539) is contained. The gas is not particularly limited as long as it is a gas which has a density of less than 1.539 and does not has a negative influence on the members inside the cell case. The gas can be filled into the cell case in advance before using the sulfide-based solid cell module of the present invention and can be filled again every time after finishing the use. Or, the gas can be continuously filled into the cell case from an external gas cylinder or the like while the sulfide-based solid cell module of the present invention is in use.

The gas having a lower density than hydrogen sulfide can be at least one kind of gas selected from the group consisting of nitrogen (N₂, density: 1.250), oxygen (O₂, density: 1.429), carbon monoxide (CO, density: 1.250), helium (He, density: 0.1785) and hydrogen (H₂, density: 0.0899). These gasses have a density of less than 1.539 in the standard condition, so that even if hydrogen sulfide is generated inside the cell case, it is unlikely that the generated hydrogen sulfide will penetrate the negative electrode on the upper side of the cell case. These gasses can be used alone or in combination of two or more kinds as a mixture.

The difference between the density of the gas filling the cell case and that of hydrogen sulfide is preferably as large as possible. Therefore, the density of the gas filling the cell case is preferably 1.52 or less, more preferably 0.08 to 1.5, and still more preferably 0.08 to 1.45.

The initial pressure of the gas filling the cell case is preferably 1 to 10 atm. When the initial pressure is less than 1 atm, since the pressure is too weak, there is a possibility that water vapor contained in the outside air is likely to enter the cell case. When the initial pressure exceeds 10 atm, since the pressure is too high, there is a possibility that the cell case is broken or the members in the sulfide-based solid cell are overloaded and the charge and discharge performance of the solid cell is affected, therefore.

The initial pressure of the gas filling the cell case is preferably 1 to 8 atm, more preferably 1 to 5 atm.

After hydrogen sulfide is generated, it is preferable in the atmosphere filling the cell case that the partial pressure of the gas having a lower density than hydrogen sulfide is higher than the partial pressure of the generated hydrogen sulfide.

### (Other Components)

A separator can be used for the present invention as other component. The separator is provided between the above-described positive and negative current collectors. In general, it functions to prevent contact between the positive and negative electrode active material layers and to retain the sulfide-based solid electrolyte. As the material for the separator, for example, there may be mentioned resins such as polyethylene (PE), polypropylene (PP), polyester, cellulose and polyamide. Of these, polyethylene and polypropylene are preferred. The structure of the separator can be a monolayer or multilayer structure. Examples of the separator having a multilayer structure include a separator having a two-layer structure (PE/PP) and a separator having a three-layer structure (PP/PE/PP). Also in the present invention, the separator can be a nonwoven fabric such as a resin nonwoven fabric or glass fiber nonwoven fabric. The thickness of the separator is not particularly limited and is the same as the thickness of the separator which is used for general sulfide-based solid cells.

As described above, in the present invention, it is possible to prevent a deterioration in negative electrode current collector and thus a decrease in cell performance. Also in the present invention, it is not needed to add a special component for avoiding contact between hydrogen sulfide and negative electrode current collector or to prepare a material which traps and detoxifies hydrogen sulfide. Therefore, the sulfide-based solid cell module of the present invention is comparable to conventional sulfide-based solid cell modules in terms of production cost, mass and volume of the whole module, etc.

### EXAMPLES

Copper, SUS and aluminum foils were exposed to a hydrogen sulfide atmosphere (H₂S concentration: 4%) for 24 hours in the temperature condition of 25° C.

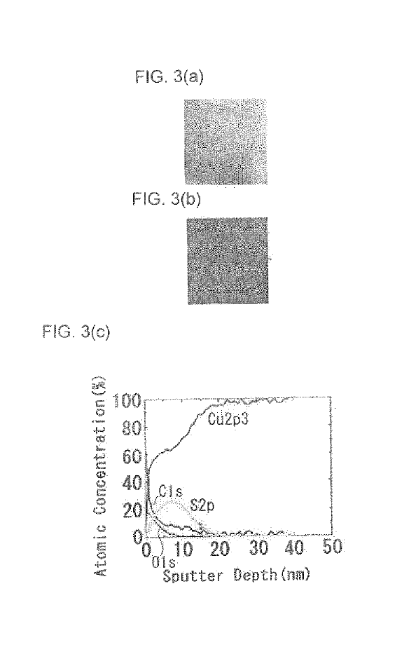

FIG. 3(a) is a photograph of the copper foil before the exposure to hydrogen sulfide. FIG. 3(b) is a photograph of the same after the exposure. As is clear from a comparison between the photographs, the copper foil turned red due to the exposure to hydrogen sulfide and it is visually clear that the foil was heavily corroded.

FIG. 3(c) is a graph showing results of X-ray photoelectron spectroscopy (XPS) depth profile analysis of the copper after the exposure. It is a graph with atomic concentration (%) on the vertical axis and sputter depth (nm) on the horizontal axis. As is clear from FIG. 3(c), diffusion of S into the copper foil proceeded 15 nm.

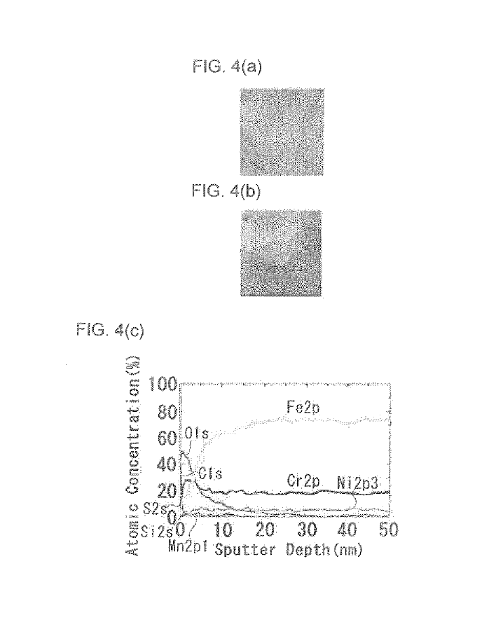

FIG. 4(a) is a photograph of the SUS foil before the exposure to hydrogen sulfide. FIG. 4(b) is a photograph of the same after the exposure. As is clear from a comparison between the photographs, the SUS foil was slightly corroded by the exposure.

FIG. 4(c) is a graph showing results of XPS depth profile analysis of the SUS after the exposure. The vertical and horizontal axes of FIG. 4(c) are the same as those of FIG. 3(c). As is clear from FIG. 4(c), diffusion of S into the SUS foil proceeded 2 nm.

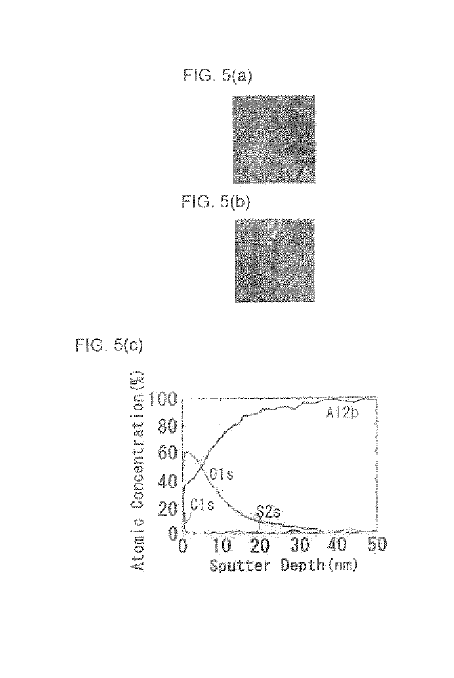

FIG. 5(a) is a photograph of the aluminum foil before the exposure to hydrogen sulfide. FIG. 5(b) is a photograph of the same after the exposure. As is clear from a comparison between the photographs, the aluminum foil was not corroded by the exposure.

FIG. 5(c) is a graph showing results of XPS depth profile analysis of the aluminum after the exposure. The vertical and horizontal axes of FIG. 5(c) are the same as those of FIG. 3(c). As is clear from FIG. 5(c), diffusion of S did not proceed in the aluminum foil.

FIG. 6 is a bar graph showing the contact resistance of the copper foil and that of the aluminum foil before and after the exposure to hydrogen sulfide. In FIG. 6, from the left, the contact resistance of the copper foil before the exposure, the contact resistance of the copper foil after the exposure, the contact resistance of the aluminum foil before the exposure, and the contact of the aluminum foil after the exposure are shown in the bar graph.

As is clear from FIG. 6, the contact resistance of the copper foil before the exposure is 0.001Ω·cm², while the contact resistance of the same after the exposure is 0.004Ω·cm². The contact resistance of the aluminum foil shows no change and is 0.005Ω·cm² before and after the exposure.

As shown in FIGS. 3(a) to 5(c), the influence of the corrosion due to the hydrogen sulfide increases in the following order: aluminum, SUS and copper. Therefore, for example, when aluminum is used for the positive electrode current collector and copper is used for the negative electrode current collector, the negative electrode current collector is expected to be more susceptible to hydrogen sulfide than the positive electrode current collector.

As shown in FIG. 6, the contact resistance of the copper foil increased four times after the exposure to hydrogen sulfide; however, the contact resistance of the aluminum foil showed no change before and after the exposure.

It is clear from the above results that, among copper, SUS and aluminum foils which are generally used for current collectors, copper foil is most heavily corroded by hydrogen sulfide. On the other hand, it is clear that aluminum foil is hardly affected by hydrogen sulfide.

### Reference Signs List

1. Sulfide-based solid electrolyte
2. Positive electrode active material layer
3. Negative electrode active material layer
4. Positive electrode current collector
5. Negative electrode current collector
6. Positive electrode
7. Negative electrode
8. Sulfide-based solid cell
9. Double-headed arrow indicating a stacking direction of the negative electrode, the sulfide-based solid electrolyte and the positive electrode of the sulfide-based solid cell
10. Cell case
11. Gas having a lower density than hydrogen sulfide
12. hydrogen sulfide
19. Double-headed arrow indicating a stacking direction of the cell cases each comprising the sulfide-based solid cell
20. Arrow indicating the vertical direction

1. A sulfide-based solid cell module comprising a sulfide-based solid cell which comprises a positive electrode, a negative electrode and a sulfide-based solid electrolyte between the positive and negative electrodes, and a cell case for housing the sulfide-based solid cell,
wherein the negative electrode is on the upper side of the vertical direction of the solid cell than the positive electrode, and
wherein a gas having a lower density than hydrogen sulfide is contained in the cell case.

2. The sulfide solid cell module according to claim 1,
wherein the negative electrode comprises a negative electrode active material layer and a negative electrode current collector, and
wherein the negative electrode current collector comprises at least one kind of electroconductive material selected from the group consisting of copper, nickel, and stainless steel.

3. The sulfide solid cell module according to claim 1, wherein the gas having a lower density than hydrogen sulfide is at least one kind of gas selected from the group consisting of nitrogen (N₂), oxygen (O₂), carbon monoxide (CO), helium (He) and hydrogen (H₂).
